(19) United States
(12) Patent Application Publication
(10) Pub. No.: US 2015/0324974 A1
(43) Pub. Date: Nov. 12, 2015

(54) COMPUTERIZED IRIDODIAGNOSIS

(71) Applicants: Miriam GARBER, (US); Oded GARBER, Kiriat Tivon (IL); EYE-CU LIFE SYSTEMS LTD., Mishmar Hashiva (IL)

(72) Inventors: Miriam GARBER, Moshav Mishmar Hashiva (IL); Oded GARBER, Kiryat Tivon (IL)

(73) Assignee: EYE-CU LIFE SYSTEMS LTD., Mishmar Hashiva (IL)

(21) Appl. No.: 14/649,310

(22) PCT Filed: Dec. 5, 2013
(86) PCT No.: PCT/IL2013/051002

§ 371 Date: Jul. 27, 2015

Related U.S. Application Data
(60) Provisional application No. 61/733,485, filed on Dec. 5, 2012.

(51) Int. Cl. G06T 7/00; G06T 7/40

(52) U.S. Cl. CPC G06T 7/0012; G06T 7/0081; G06T 7/408; G06T 2207/10024; G06T 2207/30041

(57) ABSTRACT

A method for establishing a diagnosis of a patient, the method comprising using at least one hardware processor for: acquiring an image of the patient's eye; segmenting the image into multiple areas of interest; adjusting the acquired image such that the multiple areas of interest correlate with one or more iridology maps; identifying markings in the acquired image based on a predefined Markings Types and Attributes (MTA) database; deriving the location of the identified markings according to the one or more iridology maps; querying a predefined Patient Condition Attributes Reference Table (PCART) based on one or more of the identified markings and their derived locations, to obtain one or more condition attributes of the patient; and establishing a diagnosis of the patient based on the one or more condition attributes of the patient.

### FIELD OF THE INVENTION

The present invention generally relates to the field of imaging-based patient diagnosis.

### BACKGROUND

Remote diagnostics is the act of diagnosing a given symptom, issue or problem from a distance. Instead of the subject being co-located with the person or system doing the diagnostics, with remote diagnostics the subjects can be separated by physical distance (e.g., different cities). Information exchange occurs either by wire or wireless.

Taking the above into account, there clearly remains a need, in the field of imaging-based patient diagnosis, for better more efficient systems, computerized applications and methods, wherein physical, emotional and/or behavioral attributes of a patient are at least partially diagnosed using communicated image(s) of a body part(s) of the patient's body, and corresponding body part(s) reference map(s).

The foregoing examples of the related art and limitations related therewith are intended to be illustrative and not exclusive. Other limitations of the related art will become apparent to those of skill in the art upon a reading of the specification and a study of the figures.

### SUMMARY

The following embodiments and aspects thereof are described and illustrated in conjunction with systems, tools and methods which are meant to be exemplary and illustrative, not limiting in scope.

There is provided, in accordance with an embodiment, a method for establishing a diagnosis of a patient, the method comprising using at least one hardware processor for: acquiring an image of the patient's eye; segmenting the image into multiple areas of interest; adjusting the acquired image such that the multiple areas of interest correlate with one or more iridology maps; identifying markings in the acquired image based on a predefined Markings Types and Attributes (MTA) database; deriving the location of the identified markings according to the one or more iridology maps; querying a predefined Patient Condition Attributes Reference Table (PCART) based on one or more of the identified markings and their derived locations, to obtain one or more condition attributes of the patient; and establishing a diagnosis of the patient based on the one or more condition attributes of the patient.

There is further provided, in accordance with an embodiment, a system for establishing a diagnosis of a patient, the system comprising: an image sensor; at least one hardware processor configured to: acquire, using said image sensor, an image of an eye of the patient; segment the image into multiple areas of interest; adjust the acquired image such that the multiple areas of interest correlate with one or more iridology maps; identify markings in the acquired image and based on a predefined Markings Types and Attributes (MTA) database; derive the location of the identified markings according to the one or more iridology maps; query a predefined Patient Condition Attributes Reference Table (PCART) based on one or more of the identified markings and their derived locations, to obtain one or more condition attributes of the patient; and establish a diagnosis of the patient based on the one or more condition attributes of the patient.

There is yet further provided, in accordance with an embodiment, a computer program product for establishing a diagnosis of a patient, the computer program product comprising a non-transitory computer-readable storage medium having program code embodied therewith, the program code executable by at least one hardware processor for: acquiring an image of the patient's eye; segmenting the image into multiple areas of interest; adjusting the acquired image such that the multiple areas of interest correlate with one or more iridology maps; identifying markings in the acquired image based on a predefined Markings Types and Attributes (MTA) database; deriving the location of the identified markings according to the one or more iridology maps; querying a predefined Patient Condition Attributes Reference Table (PCART) based on one or more of the identified markings and their derived locations, to obtain one or more condition attributes of the patient; and establishing a diagnosis of the patient based on the one or more condition attributes of the patient.

In some embodiments, the method further comprises using the at least one hardware processor for constructing the MTA database.

In some embodiments, the image of the patient's eye comprises two images, each for each one of the patient's eyes.

In some embodiments, the image is an RGB image.

In some embodiments, segmenting the image into multiple areas of interest comprises further segmenting the image into anatomical zones of the different areas of interest, as specified in the one or more iridology maps.

In some embodiments, the areas of interest comprise one or more of the iris, the sclera or the pupil of the patient's eye.

In some embodiments, the markings comprise one or more of lacunas, cholesterol rings, color spots, red lines, narrowing lines, widening lines or bulges.

In some embodiments, the system further comprises a mobile device which comprises said image sensor and said hardware processor.

In some embodiments, said mobile device is a smart phone.

In some embodiments, the system further comprises: a communication device running a mobile application which comprises said image sensor; and a server which comprises said hardware processor and being in communication with said communication device running a mobile application over a wide area network (WAN).

In some embodiments, the at least one hardware processor is further configured to construct the MTA database.

In some embodiments, the at least one hardware processor is further configured to segment the image into anatomical zones of the different areas of interest, as specified in the one or more iridology maps.

In some embodiments, the program code is further executable by the at least one hardware processor to segment the image into anatomical zones of the different areas of interest, as specified in the one or more iridology maps.

In some embodiments, the program code is further executable by the at least one hardware processor to construct the MTA database.

In addition to the exemplary aspects and embodiments described above, further aspects and embodiments will become apparent by reference to the figures and by study of the following detailed description.

### BRIEF DESCRIPTION OF THE DRAWINGS

Exemplary embodiments are illustrated in referenced figures. Dimensions of components and features shown in the figures are generally chosen for convenience and clarity of presentation and are not necessarily shown to scale. The figures are listed below.

FIG. 1 is a flow chart showing the main steps executed as part of an exemplary method for establishing a diagnosis of a patient, (i.e., diagnosing physical, emotional and/or behavioral attributes of a patient), in accordance with some embodiments of the disclosed technique;

FIG. 2 is a block diagram showing the main modules and configuration of an exemplary system for establishing a diagnosis of a patient (i.e., diagnosing physical, emotional and/or behavioral attributes of a patient), in accordance with some embodiments of the disclosed technique;

FIG. 3 is a block diagram showing the main modules and configuration of an exemplary system for diagnosing physical, emotional and/or behavioral attributes of a patient wherein, the system is implemented using a communication device running a mobile application and a networked Server, in accordance with some embodiments of the disclosed technique; and

FIGS. 4A-4D are schematic drawings of exemplary markings identified by an Image Markings Identifying and Locating Module in a scanning of an acquired digital image of a patients' body part, in accordance with some embodiments of the disclosed technique.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a hardware processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowcharts and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Present embodiments provide a system, method, computer program product and mobile application for diagnosing physical, emotional and/or behavioral attributes of a patient.

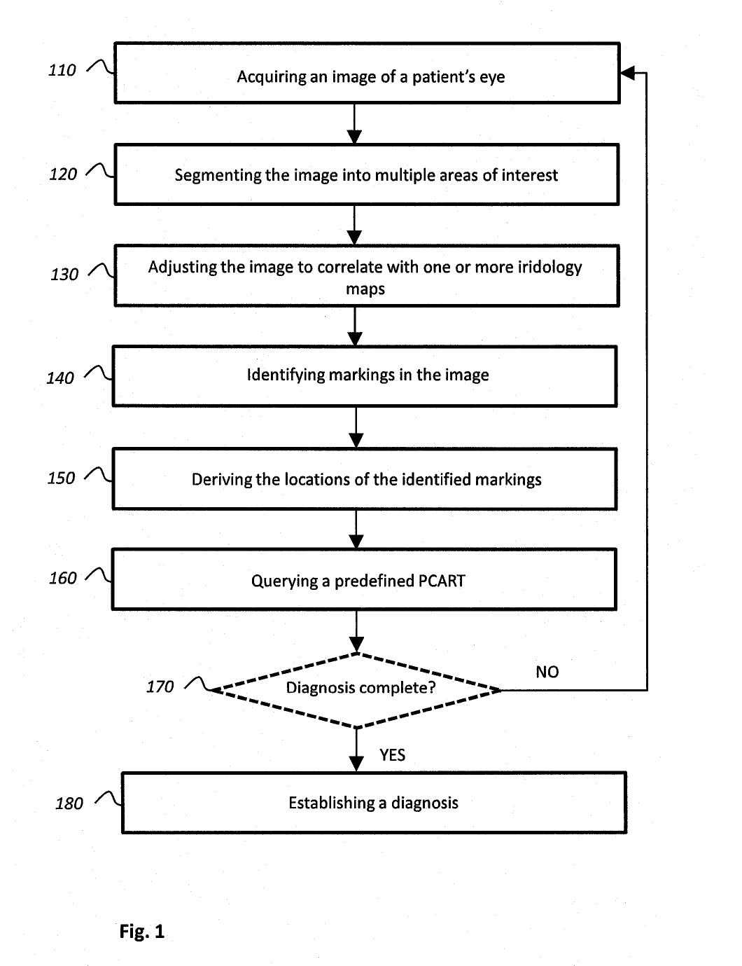

FIG. 1 is a flow chart showing the main steps executed as part of an exemplary method for establishing a diagnosis of a patient, (i.e., diagnosing physical, emotional and/or behavioral attributes of a patient), in accordance with some embodiments of the disclosed technique. In a step 110, one or more digital images of one or both the patient's eyes are acquired. The images are optionally high quality RGB images in resolution of at least 8 to 24 megapixels. The image may be acquired by using one or more image sensors as known in the art.

In a step 120, the image is segmented into multiple areas of interest. Such areas of interest may be, for example, the iris, the sclera and/or the pupil of the imaged eye. The segmentation may be performed by using color segmentation and/or border finding, as known in the art. Further image processing may be performed, such as noise reduction (e.g., by removing irrelevant components such as eyelashes).

In a step 130, the acquired image is adjusted such that the multiple areas of interest correlate with one or more iridology maps. The adjusting may be performed, for example, by scaling, stretching and/or contracting the image in one or two dimensions. Various iridology maps, as known in the art, may be used for this purpose. In an optional step, further segmentation of the imaged eye may be performed according to the anatomical zones of the different areas of interest, as specified in the one or more iridology maps.

In a step 140, markings in the acquired image are identified by predefined markings attributes and based on a predefined Markings Types and Attributes (MTA) database. The identification may be performed, for example, by using commonly known machine learning techniques. For instance, one or more iridology professionals may be presented with images having different markings; the professionals identify the markings by eyeballing, and their identification is used as training input into a machine learning algorithm.

The MTA database generally includes types of markings and their associated attributes such that types of markings may be identified in the image by identifying their associated attributes. Markings types may include lacunas, cholesterol rings, skin rings, color spots, red lines, narrowing or widening lines, pigments and bulges. The associated attributes may include, for example: size, depth and color.

In an optional step, an MTA database may be constructed. The construction of such a database may be performed by analyzing multiple images of eyes (right and left) using color segmentation and/or machine learning techniques, as known in the art. These techniques and processes may be used to segment areas of interest and anatomical zones in the images according to the one or more iridology maps, to characterize these zones (e.g., by attributes such as color or shape) and to identify irregularities, such as different type of markings. For example, such step may include: segmentation of the area of interest: pupil, iris and sclera of the eye; evaluation of the size of each area (e.g., large, medium or small); evaluation of the color of each area (e.g., blue, brown, green, black, red, yellow, orange, grey or white; and dark, light, shiny or mat); evaluation of the depth of the area (iris layer, sclera layer); evaluation of tissue structure (strong or weak density) and evaluation of the shape of the area (line: long or short, circle, ellipse: perfect or distorted).

In a step 150, the location of the identified markings is derived according to the one or more iridology maps. This is performed based on the adjustment of the image to the one or more iridology maps according to step 130. As commonly known, an iridology map generally divides the iris and sclera areas of the eye into anatomical zones representing various anatomical parts or zones of the human body. Thus, the identified markings are located in these zones.

In a further optional step, additional markings attributes may be identified and such as center and radius of the pupil and iris, or combinations of various markings in the same zone.

In a step 160, a predefined Patient Condition Attributes Reference Table (PCART) is queried. The querying is performed based on one or more of the identified markings, their identified attributes and their derived locations and in order to obtain one or more condition attributes of the patient. The PCART generally associates markings characterized by attributes, including location, to a physical, mental and/or behavioral condition of a patient. Such a table may be constructed according to the known iridology theory and principles. Thus, the marking, their attributes and locations as identified in the image are matched to the markings characterized by attributes in the PCART in order to obtain an input with respect to the patient's physical, mental and/or behavioral condition.

In an optional step 170, the option of acquiring an additional image may be considered and if such is required in order to complete the diagnosis. An additional image may be required in case the image is not clear, or in order to receive further information, as described in the examples below. An additional image may be an image of the other eye (in case only one image of one eye was acquired), another image of the same eye or of a specific zone of the eye.

In a step 180, a diagnosis of the patient based on the one or more condition attributes of the patient is established. The diagnosis may be established by considering the overall input obtained from all of the identified markings and their attributes and their mutual influence.

The method of FIG. 1 may be performed automatically by a system in accordance with the disclosed technique. The method of FIG. 1 may be performed at least partially by executing, using at least one hardware processor, a computer program product in accordance with the disclosed technique or may be partially performed by an iridologist. For example, an image may be acquired and analyzed automatically according to steps 110-150. The identified markings and their locations and optionally their identified attributes may be presented to the iridologist. The iridologist may then perform steps 160 and 170, i.e., analyze the identified markings according to their attributes and locations and establish a diagnosis of the patient's condition. The identified markings and their locations and optionally their identified attributes may be presented in various manners, such as, displayed as a list or as an image on a display.

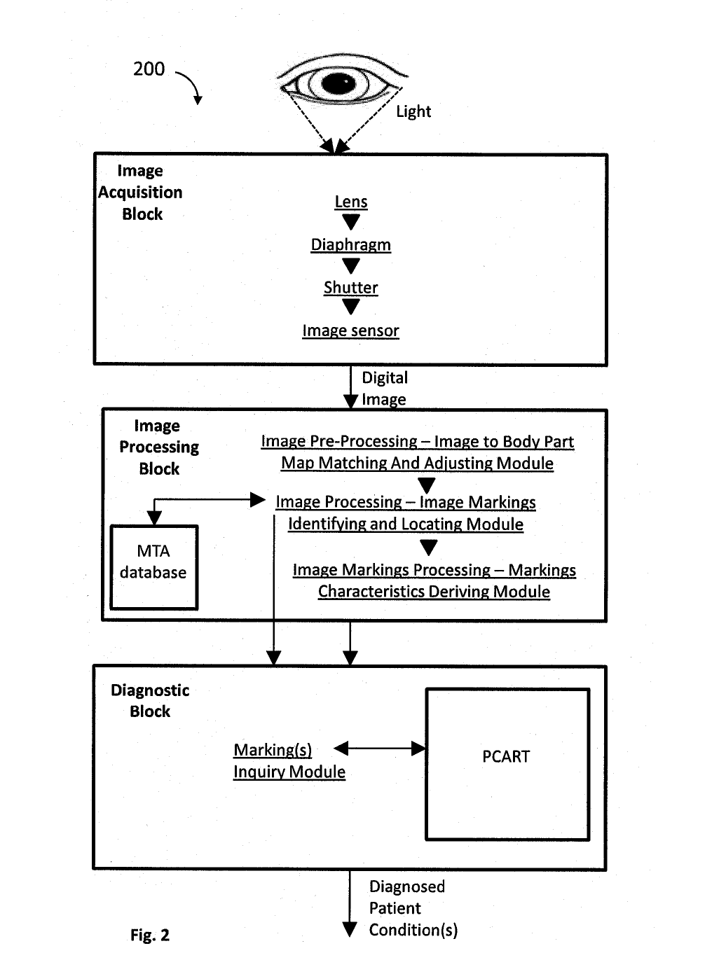

FIG. 2 is a block diagram showing the main modules and configuration of an exemplary system 200 for establishing a diagnosis of a patient (i.e., diagnosing physical, emotional and/or behavioral attributes of a patient), in accordance with some embodiments of the disclosed technique. System 200 generally operates in accordance with the method of FIG. 1.

System 200 may include at least one hardware processor (not shown) operatively coupled with: an Image Acquisition Block 210 including an image sensor for acquiring an image of a patients' body part (e.g. an eye); an Image Processing Block 220 for identifying, locating and characterizing one or more markings and/or attributes in the acquired image; and a Diagnostics Block 230 for diagnosing one or more attributes/conditions of the patient at least partially based on the characteristics of the identified markings and/or attributes.

According to some embodiments of the disclosed technique, the Image Acquisition Block may further include: a lens for focusing light from the photographed body part of the patient; a diaphragm for controlling the amount of light traveling towards an image sensor and a shutter for allowing a timed exposure of the image sensor to the light. The Image Sensor produces a digital image based on the amount of light it was exposed to.

According to some embodiments of the disclosed technique, the Image Processing Block may include: an Image to Body Part Map (e.g., one or more iridology maps) Matching and Adjusting Module; an Image Markings Identifying and Locating Module; and a Markings Characteristics Deriving Module.

According to some embodiments of the present invention, the Image to Body Part Map Matching and Adjusting Module, or Image Pre-Processing Module, may scale, stretch and/or contract the digital image in one or two dimensions so as to matched it to, and/or adjust it to overlap, a corresponding body part map(s), such as an iridology map, or parts thereof.

According to some embodiments of the disclosed technique, the Image Markings Identifying and Locating Module, or Image Processing Module, may identify markings found in a scanning of the digital image by referencing a Markings Types and Attributes (MTA) database. The locations of the markings found in the scanning of the digital image and identified in the MTA database may then be recorded. Using the recorded markings locations, and the Corresponding Body Part Map to which the digital image was matched and adjusted, respective ‘map locations’/′zones of appearance in map′ may be correlated to one or more of the identified markings.

According to some embodiments of the disclosed technique, the Markings Characteristics Deriving Module, or Image Markings Processing Module, may scan the digital image and derive: size, depth, direction and/or color related characteristics, and/or any other optical characteristic, of one or more of the identified markings.

According to some embodiments of the disclosed technique, the Diagnostics Block may comprise a Markings Inquiry Module. The Markings Inquiry Module may use the markings correlated ‘map locations’/‘zones of appearance in map’, and the derived markings characteristics, to query a Patient Condition Attributes Reference Table (PCART). The PCART may thus be used to correlate one or more physical, mental/emotional and/or behavioral attributes to the patient whose image was acquired. Based on the correlated physical, mental/emotional and/or behavioral attributes—a patient diagnosis may be established.

The following exemplary PCART describes some possible markings attributes and locations associated with a patient's condition as a part of an exemplary system or may be utilized by an exemplary method for diagnosing physical, emotional and/or behavioral attributes of a patient, in accordance with some embodiments of the disclosed technique. The listed patient's conditions, in this exemplary case, are at least partially based on: characteristics derived by the Markings Characteristics Deriving Module, of markings identified by the Image Markings Identifying and Locating Module, in a digital image of a patient's eye acquired by Image Acquisition Block; and the locations of these markings in a corresponding map of a human eye, established by the Image Markings Identifying and Locating Module. The possible patient's conditions listed in this exemplary table may be based on: (1) markings located on the Iris of the patient's eye, (2) markings located on the sclera of the patient's eye, and (3) markings located on the pupil of the patient's eye.

### Iris

| | | | Contraction | |
|---|---|---|---|---|
| | | | Furrows | |
| | | | Location = | |
| Struc- | | | age and organ | |
| ture | Color | Shape | affected | Patient's Condition |
| Weak | Blue | Round | | Lymph problems |
| Tissue | | | | & weak immune |
| | | | | system |
| Strong | Brown | Round | One or More | Strong body, weak |
| Tissue | | | | thyroid function, |
| | | | | enervation and |
| | | | | trauma at the age |
| | | | | of 5 |
| Line | White | Straight or | | Inflammation and |
| | | Curved | | organ irritation |
| | Green- | | | Gastro-intestinal |
| | brownish | | | condition |
| | (mixed | | | |
| | constitution | | | |
| | of blue and | | | |
| | green eye | | | |
| | attributes) | | | |

### Sclera

| | | | | | Patient's |
|---|---|---|---|---|---|
| Lines | Color | Location | Shape | Thickness | Condition |
| Straight | Red | Liver | Fork | Thick | A Potential Of |
| | | | | | A Tumor In The |
| | | | | | Liver |
| | Yellow | Large Parts | | | |
| | | Of The | | | |
| | | Sclera | | | |
| Wobbly | Red | Kidney | Fork | Thin To | High Risk Of |
| | | | | Thick | Stones In The |
| | | | | | Kidney |
| Circle | Blue | Coronary | Half | Thick | Chronic Stress + |
| | | Veins | Circle | | Arterial/Venous |
| | | | Facing | | Congestion |
| | | | To The | | |
| | | | Center | | |

### Pupil

| | | | | | Patient's |
|---|---|---|---|---|---|
| Structure | Color | Shape | Location | Markings | Condition |
| | Grey | Any | At the | A grey | Cataract |
| | | | center of | cloud like | |
| | | | the Iris | marking | |
| | | | | covering | |
| | | | | the pupil | |

According to some embodiments of the disclosed technique, the diagnosis may, in some cases, include respective practical recommendations for prevention, treatment and/or further care or advice. According to some embodiments, warnings or notifications may be issued to users or patients, intermittently, and/or when issuing or relaying or communicating patient diagnostics. Such warnings or notifications may be, for example: ‘The diagnostics and/or recommendations made and/or provided by the system do not replace the seeking of professional medical advice where needed nor the consulting of a doctor of conventional medicine prior to making any changes to any type of previously prescribed treatment’.

Various additional exemplary markings locations and characteristics, and corresponding patient condition attributes and diagnostics, are described in the following publication: “Iridology in Practice—Revealing the Secrets of the Eye”, Miriam Garber, Ph.D.MBMD, Dip. H. Ir Basic Health Publications Inc., ISBN: 978-1-59120-360-5. This publication is hereby incorporated by reference in its entirety.

### Exemplary Diagnostic Processes

The following are two exemplary diagnostic processes, made using an iridology map of the human left eye (serving here merely as an example), as known in the art. The map is divided into zones some of which are defined by a radial size. The zones generally represent different anatomical parts or areas of the human body.

### Example 1

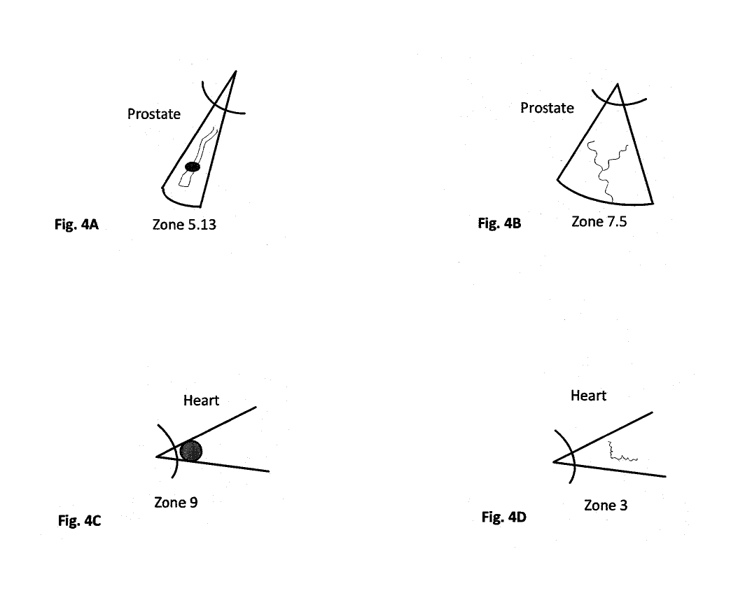

An image of the eye corresponding to the iridology map is provided by the Image Acquisition Block.
The Image to Body Part Map Matching and Adjusting Module scales, stretches and/or contracts the digital image to match the iridology map.
The Image Markings Identifying and Locating Module identifies a marking in a zone 5.13 of the map in a scanning of the digital image (as shown in FIG. 4A).
The Markings Characteristics Deriving Module derives characteristics of the identified marking determining it to be a Black Spot.
The Diagnostic Block queries the PCART and learns that the associated condition of a Dark Black Spot in zone 5.13 is a potential to Malignancy.
As zone 5.13 represents, among other zones, the prostate in the human body and in zone 7.5 of the map the human prostate is also reflected, zone 7.5 may be also examined using the same and/or additional or other images of the patient's eye.
The Image Markings Identifying and Locating Module identifies a marking in zone 7.5 of the map in a scanning of the digital image (as shown in FIG. 4B).
The Markings Characteristics Deriving Module derives characteristics of the identified marking determining it to be a Curly Red Line.
The Diagnostic Block queries the PCART, and learns that adding the finding of the Curly Red Line in zone 7.5 to the Dark Black Spot in zone 5.13 further increases the odds that a Malignant tumor is pruned to develop in the Prostate of the analyzed human body (i.e., patient) and that an urgent check up is immediately needed.

### Example 2

An image of the eye corresponding to the map is provided by the Image Acquisition Block.
The Image to Body Part Map Matching and Adjusting Module scales, stretches and/or contracts the digital image to match the map.
The Image Markings Identifying and Locating Module identifies a marking in zone 9 of the map in a scanning of the digital image (as shown in FIG. 4C).
The Markings Characteristics Deriving Module derives characteristics of the identified marking determining it to be a Lake Shaped Dark Gray Area.
The Diagnostic Block queries the PCART and learns that the condition corresponding to a Lake Shaped Dark Gray Area in zone 9 is a potential to Chronic Pathology close to Entropy of the Human Organ.
As zone 9 represents, among other zones, the heart in the human body and in zone 3 of the map the human heart is also reflected, zone 3 is examined by using the same and/or additional or other images of the patient's eye.
The Image Markings Identifying and Locating Module identifies a marking in zone 3 of the map in a scanning of the digital image (as shown in FIG. 4D).
The Markings Characteristics Deriving Module derives characteristics of the identified marking determining it to be a Curly Red Horizontal Line Turning Upwards.
The Diagnostic Block queries the PCART, and learns that adding of the Curly Red Horizontal Line Turning Upwards in zone 3 to the Lake Shaped Dark Gray Area in zone 9 results in a sign of a potential heart attack prone to happen in the Heart of the analyzed human body and that an urgent check up is immediately needed.

One should note that depending on the individual body examined, various other markings or combinations thereof, may under certain given constellations point to similar conclusion(s) or diagnostic(s).

### Mobile Application Embodiment

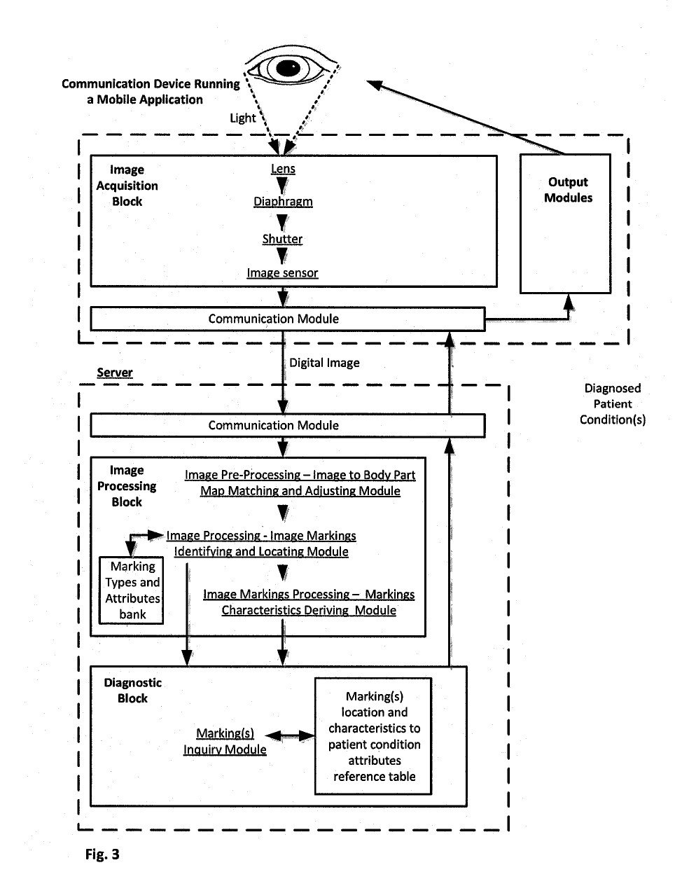

FIG. 3 is a block diagram showing the main modules and configuration of an exemplary system for diagnosing physical, emotional and/or behavioral attributes of a patient wherein, the system is implemented using a communication device running a mobile application (such as a smart phone, a tablet computer, etc.), and a networked server, in accordance with some embodiments of the disclosed technique. The system is generally similar to system 200 of FIG. 2 with the modifications described herein below.

According to some embodiments of the present invention, a system for diagnosing physical, emotional and/or behavioral attributes of a patient may, for example, be implemented using a communication device running a mobile application, which includes an image sensor and a server.

According to some embodiments, the mobile application may utilize the camera (i.e., image sensor) of the communication device it is installed on, as the system's Image Acquisition Block (described hereinbefore), for acquiring digital image(s) of a patient's body part (e.g. the mobile device user). The mobile application may store the acquired digital image(s) on one or more data storage module(s) or media(s) of the communication device or functionally-associated-with it, and/or use a communication module of the device to communicate one or more of the acquired digital images to the Server.

According to some embodiments, the server may implement the Image Processing and Diagnostic Blocks (described hereinbefore) (i.e., by utilizing a hardware processor). According to some embodiments, the MTA database, and/or the PCART, may be implemented using data storage module(s) of the Server and/or using data storage module(s) networked to the Server. The Server may include a communication module which may be utilized for communicating with the mobile device over a wide area network (WAN) (e.g., the internet). The server may use the communication module for receiving the acquired digital images, communicated by the mobile device, and for communicating to the mobile device data related-to or indicative-of one or more of the diagnosed condition(s) and/or attribute(s) of the patient whose image was acquired (e.g. the mobile device user).

According to some embodiments, the mobile application may use the communication module of the device to receive the data related-to or indicative-of one or more of the diagnosed condition(s) and/or attribute(s) of the patient, communicated by the server. The mobile application may store the diagnosed condition(s) and/or attribute(s) data on one or more data storage module(s) or media(s) of the communication device or functionally-associated-with it, and/or use one or more output modules of the communication device (e.g., a display) to present to the user the diagnosed condition(s) and/or attribute(s) data of the patient and/or data that is at least partially based-on or derived-from the diagnosed condition(s) and/or attribute(s) data of the patient.

According to some embodiments, system 200 of FIG. 2 may further include a mobile device, which includes the image sensor and the hardware processor. Thus, system 200 may be embodied in a mobile device.

The disclosed technique may be embodied in mobile or stationary devices. A stationary device may be, for example, a personal computer or a terminal. A mobile device or a communication device running a mobile application according to the disclosed technique may be, for example, a smart phone, a tablet computer, a laptop or a Personal Digital Assistant. The terminal may be, for example, a photobooth in which a patient may have his or her eyes photographed; the images are transmitted, over a network, to an analysis server, and the results are displayed back to the user at the photobooth.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for establishing a diagnosis of a patient, the method comprising using at least one hardware processor for:
acquiring an image of the patient's eye;
segmenting the image into multiple areas of interest;
adjusting the acquired image such that the multiple areas of interest correlate with one or more iridology maps;
identifying markings in the acquired image based on a predefined Markings Types and Attributes (MTA) database;
deriving the location of the identified markings according to the one or more iridology maps;
querying a predefined Patient Condition Attributes Reference Table (PCART) based on one or more of the identified markings and their derived locations, to obtain one or more condition attributes of the patient; and
establishing a diagnosis of the patient based on the one or more condition attributes of the patient.

2. The method of claim 1, further comprising using the at least one hardware processor for constructing the MTA database.

3. The method of claim 1, wherein the image of the patient's eye comprises two images, each for each one of the patient's eyes.

4. The method of claim 1, wherein the image is an RGB image.

5. The method of claim 1, wherein segmenting the image into multiple areas of interest comprises further segmenting the image into anatomical zones of the different areas of interest, as specified in the one or more iridology maps.

6. The method of claim 1, wherein the areas of interest comprise one or more of the iris, the sclera or the pupil of the patient's eye.

7. The method of claim 1, wherein the markings comprise one or more of lacunas, cholesterol rings, color spots, red lines, narrowing lines, widening lines or bulges.

8. A system for establishing a diagnosis of a patient, the system comprising:
an image sensor;
at least one hardware processor configured to:
acquire, using said image sensor, an image of an eye of the patient;
segment the image into multiple areas of interest;
adjust the acquired image such that the multiple areas of interest correlate with one or more iridology maps;
identify markings in the acquired image and based on a predefined Markings Types and Attributes (MTA) database;
derive the location of the identified markings according to the one or more iridology maps;
query a predefined Patient Condition Attributes Reference Table (PCART) based on one or more of the identified markings and their derived locations, to obtain one or more condition attributes of the patient; and
establish a diagnosis of the patient based on the one or more condition attributes of the patient.

9. The system according to claim 8, further comprising a mobile device which comprises said image sensor and said hardware processor.

10. The system according to claim 9, wherein said mobile device is a smart phone.

11. The system of claim 8, further comprising:
a communication device running a mobile application which comprises said image sensor; and
a server which comprises said hardware processor and being in communication with said communication device running a mobile application over a wide area network (WAN).

12. The system of claim 8, wherein the at least one hardware processor is further configured to construct the MTA database.

13. The system of claim 8, wherein the image of the patient's eye comprises two images, each for each one of the patient's eyes.

14. The system of claim 8, wherein the image is an RGB image.

15. The system of claim 8, wherein the at least one hardware processor is further configured to segment the image into anatomical zones of the different areas of interest, as specified in the one or more iridology maps.

16. The system of claim 8, wherein the areas of interest comprise one or more of the iris, the sclera or the pupil of the patient's eye.

17. A computer program product for establishing a diagnosis of a patient, the computer program product comprising a non-transitory computer-readable storage medium having program code embodied therewith, the program code executable by at least one hardware processor for:
acquiring an image of the patient's eye;
segmenting the image into multiple areas of interest;
adjusting the acquired image such that the multiple areas of interest correlate with one or more iridology maps;
identifying markings in the acquired image based on a predefined Markings Types and Attributes (MTA) database;
deriving the location of the identified markings according to the one or more iridology maps;
querying a predefined Patient Condition Attributes Reference Table (PCART) based on one or more of the identified markings and their derived locations, to obtain one or more condition attributes of the patient; and
establishing a diagnosis of the patient based on the one or more condition attributes of the patient.

18. The computer program product of claim 17, wherein the program code is further executable by the at least one hardware processor to segment the image into anatomical zones of the different areas of interest, as specified in the one or more iridology maps.

19. The computer program product of claim 17, wherein the program code is further executable by the at least one hardware processor to construct the MTA database.

20. The computer program product of claim 17, wherein the image of the patient's eye comprises two images, each for each one of the patient's eyes.
